(19) United States
(12) Patent Application Publication
(10) Pub. No.: US 2007/0080032 A1
(43) Pub. Date: Apr. 12, 2007

(54) Disc brake

(76) Inventor: Takashi Sano, Kai-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/526,021

(22) Filed: Sep. 25, 2006

(30) Foreign Application Priority Data
Sep. 30, 2005 (JP) 288337/2005

(51) Int. Cl. F16D 55/00

(52) U.S. Cl. 188/73.31; 188/73.37

(57) ABSTRACT

A disc brake designed to prevent formation of a pressure recess caused by a braking operation when a vehicle is moving forward, and reduce rattling caused by a braking operation when the vehicle is moving rearward. The disc brake comprises: a caliper body including pistons that are disposed in opposing relation to each other on either side of a disc; and a plurality of brake pads that are disposed in pairs on either side of the disc. The caliper body is provided with: forward torque-receiving surfaces for receiving a braking torque from the brake pads during a braking operation when the vehicle is moving forward; and rearward torque-receiving surfaces for receiving a braking torque from the brake pads during a braking operation when the vehicle is moving rearward. Only the forward torque-receiving surfaces are provided with guide members for abutment with the brake pads, while the rearward torque-receiving surfaces can be brought into direct contact with the brake pads. The caliper body is made of a material having a hardness lower than that of the guide members.

### BACKGROUND OF THE INVENTION

1. Technical Field

The present invention relates to a disc brake for brake control of rotation of a vehicle axle.

2. Prior Art

In a known vehicle disc brake, brake pads for gripping a disc are provided at opposing lateral sides of the disc and are slidably held by a caliper body made of a material such as an aluminum alloy. In this way, the disc pads can be pressed by pressing means, that is, opposed pistons into contact with the lateral sides of the disc. Further, the caliper body of the disc brake includes pad-holding portions that are provided with toque-receiving surfaces for the brake pads to receive a reaction force exerted by the disc in a direction of rotation of the disc during a braking operation.

However, since the caliper body of this disc brake is made of a metal having a relatively low hardness such as an aluminum alloy, there is a possibility that the torque-receiving surfaces may become recessed when subject to a large torque during a braking operation.

To address this problem, it has been proposed to provide such torque receiving surfaces with guide members made of a high-hardness material such as a steel (see, for example, Japanese Patent Public Disclosure No. HEI 08-21463).

However, it is difficult for this conventional disc brake to satisfy required braking performances for both forward and rearward movements of the vehicle, since a guide member of an equally hard material are provided on a torque-receiving surface in each direction of rotation of the disc.

More specifically, it is strongly desired to prevent a forward torque-receiving surface from being recessed or the like due to pressure, since it frequently receives a large braking torque during a braking operation when the vehicle is moving forward. On the other hand, in a braking operation when the vehicle is moving rearward, reduction of rattling (striking noise) rather than prevention of formation of a recess or the like is desired, since the vehicle speed is low at the time of the rearward braking operation, and a braking torque exerted on a rear torque-receiving surface is small. The rattling occurs, in particular, when the brake pads and pad-backing metal portions, which have been pressed against the forward torque-receiving surface in a forward movement of the vehicle, suddenly collide with the rearward torque-receiving surface in a braking operation when the vehicle is moving rearward. Therefore, if a guide member is made of a hard material with a view to preventing formation of a pressure recess or the like caused by a braking operation of a forward moving vehicle, the guide member is more likely to rattle during a rearward braking operation of a vehicle.

Therefore, an object of the present invention is to provide a disc brake that are designed to prevent a recess from being formed due to pressure caused by a braking operation when a vehicle is moving forward and reduce rattling during a braking operation when the vehicle is moving rearward.

### SUMMARY OF THE INVENTION

To achieve the above-described object, the present invention is directed to a disc brake including a caliper body having a plurality of pressing means that are disposed, via a disc pass portion, in opposing relation to each other on either side of a disc, which is adapted to rotate with a vehicle axle, such that a pair of brake pads, which are disposed on either side of the disc, are supported by the caliper body so as to be capable of slidably moving in an axial direction of a disc, the caliper body comprising:

forward torque-receiving surfaces for receiving a braking torque from the brake pads during a braking operation when a vehicle is moving forward; and rearward torque-receiving surfaces for receiving a braking torque from the brake pads during a braking operation when the vehicle is moving rearward, the forward torque-receiving surfaces and the rearward torque-receiving surfaces being provided in symmetrical relation to each other in a circumferential direction of the disc, wherein only the forward torque-receiving surfaces are each provided with a guide member for abutment with the brake pads, while the rearward torque-receiving surfaces can be brought into direct contact with the brake pads, and wherein the caliper body is made of a material having a hardness lower than that of the guide members.

The present invention also provides a disc brake comprising:

a caliper body having a plurality of pressing means that are disposed, via a disc pass portion, in opposing relation to each other on either side of a disc, which is adapted to rotate with a vehicle axle;

a pair of brake pads which are disposed on either side of the disc, the brake pads being supported by the caliper body so as to be capable of slidably moving in an axial direction of a disc;

the caliper body comprising torque receiving surfaces on which the brake pads abut during a vehicle braking operation, each of the torque receiving surfaces being provided with a guide member, wherein hardness of the guide members on the rearward torque-receiving surfaces, on which the brake pads abut during a braking operation when the vehicle is moving rearward, is lower than that of the guide members on the forward torque-receiving surfaces, on which the brake pads abut during a braking operation when the vehicle is moving forward.

### BRIEF DESCRIPTION OF THE DRAWINGS

FIG. 1 is a plan view of a disc brake according to a first embodiment of the present invention.

FIG. 2 is a front view of the disc brake of the first embodiment.

FIG. 3 is a cross-sectional view of the disc brake of the first embodiment taken along the line A-A of FIG. 1.

FIG. 4 is a perspective view of a guide member of the disc brake of the first embodiment.

FIG. 5 (A) is a plan view of a caliper body according to a modified example of the first embodiment, while FIG. 5 (B) is a cross-sectional view of the caliper body taken along the line B-B of FIG. 5(A).

FIG. 6 (A) is a plan view of a caliper body according to the modified example of the first embodiment, while FIG. 6 (B) is a cross-sectional view of the caliper body taken along the line C-C of FIG. 6 (A).

FIG. 7 (A) is a plan view of a caliper body according to the modified example of the first embodiment, while FIG. 7 (B) is a cross-sectional view of the caliper body taken along the line D-D of FIG. 7 (A).

FIG. 8 is a plan view of a disc brake according to a second embodiment of the present invention.

FIG. 9 is a cross-sectional view of the disc brake of the second embodiment taken along the line E-E of FIG. 8.

FIG. 10 is a perspective view of a guide member of the disc brake of the second embodiment.

FIG. 11 is a cross-sectional view of a disc brake according to a third embodiment of the present invention.

FIG. 12 is a perspective view of a guide member of the disc brake of the third embodiment.

FIG. 13 is a plan view of a disc brake according to a fourth embodiment of the present invention.

FIG. 14 is a cross-sectional view of the disc brake of the fourth embodiment taken along the line F-F of FIG. 13.

FIG. 15 is a cross-sectional view of a disc brake according to a fifth embodiment of the present invention.

### DETAILED DESCRIPTION OF THE INVENTION

Below, embodiments of the present invention will be described with reference to the accompanying drawings. It is to be noted that like elements are denoted by like reference numerals in the following embodiments, and repetitive descriptions thereof are omitted.

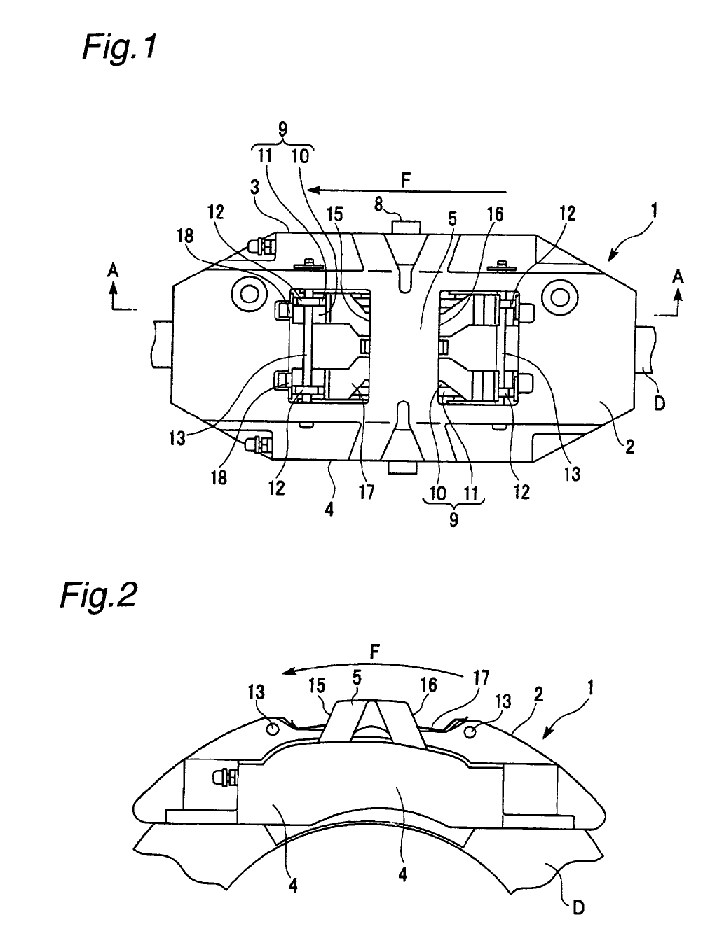

First, the disc brake according to the first embodiment of the present invention will be described with reference to FIGS. 1 to 4.

This disc brake comprises: a brake disc (disc) D adapted to rotate with an axle; and a brake caliper 1 fixed to the side of a vehicle body. A caliper body 2 of the brake caliper 1 is made of a single block of an aluminum alloy (for example, AC1B-T4, AC2A-T6, or AC4CH-T6). It is to be noted that an arrow F in the figures indicates a direction of rotation of the brake disc D when a vehicle moves forward, and that a hardness of the aluminum alloy used in the caliper body 2 of the present embodiment is about Hv 90.

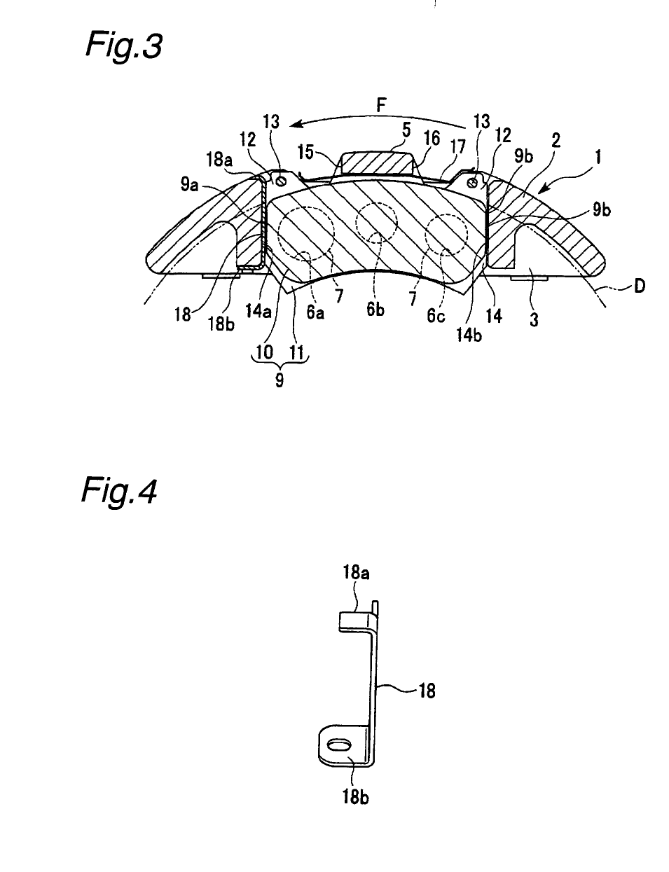

As shown in FIG. 2, the caliper body 2 is formed to be substantially arc shaped from a lateral view point, and has a guide groove (not shown) in an inner circumferential side of the arc, the guide groove being formed to cover an outer circumferential edge of the disc D. This guide groove is defined by: an inner wall 3 facing a surface of the disc D on an inboard side of the vehicle; an outer wall 4 facing a surface of the disc D on an outboard side of the vehicle; and an outer circumferential wall 5 (a disc pass portion) connecting the inner and outer walls 3 and 4 over an outer circumferential side of the disc D. As shown in FIG. 3, the inner and outer walls 3 and 4 have three bores 6a, 6b, and 6c provided on opposing surfaces thereof in an axial direction of the disc, the bores 6a, 6b, and 6c being disposed in a direction of disc rotation. A piston 7 serving as a pressing means is fitted into each of the bores 6a, 6b, and 6c so as to be capable of moving forward and rearward. These pistons 7 are hydraulically actuated by a brake fluid supplied through a port 8 (see FIG. 1) of the caliper body 2 to perform brake control of the disc. In the present embodiment, the brake caliper 1 has a structure of a so-called opposed-piston 6-pod caliper.

In the caliper body 2, a pair of brake pads 9, which can be pressed into contact with opposite lateral sides of the disc D, are held so as to be movable forward and rearward along the disc axis. The brake pads 9 each have a friction member 10 for direct pressing contact with a lateral surface of the disc D; and a metal backing member 11 for supporting the friction member 10, a rear surface of the metal backing member 11 being adapted to be pressed by the pistons 7. The brake pads 9 are formed to be substantially arc shaped from a lateral view point, and have end surfaces 9a and 9b that are formed to be parallel to each other on opposing sides of each of the brake pads 9 in the rotational direction of the disc. In other words, the ends of each of the brake pads 9 located in the rotational direction of the disc are symmetrical. The metal backing members 11 each have support bosses 12 projecting from opposite upper peripheral portions thereof. The support bosses 12 are slidably inserted in and supported by pad pins 13 that are attached to the caliper body 2 and that are oriented in the axial direction of the disc.

Opposing surfaces of the inner and outer walls 3 and 4 of the caliper body 2 each have a guide groove 14 for accommodating and slidably supporting the respective brake pad 9. The guide grooves 14 each have end surfaces 14a and 14b that are located opposite to each other in the rotational direction of the disc. The end surfaces 14a and 14b are provided in symmetrical relation to each other in a circumferential direction of the disc D and receive a reaction force (a torque) exerted by the disc D in a direction of rotation which acts on the brake pads 9 when the brake pads 9 are pressed against the disc D at a time of braking. Below, the end surface 14a for receiving a torque at a time of braking when the vehicle is moving forward is referred to as a forward torque-receiving surface 14a, and the end surface 14b for receiving a torque at a time of braking when the vehicle is moving rearward is referred to as a rearward torque-receiving surface 14b.

The outer circumferential wall 5 of the caliper body 2 is provided with a pair of windows 15 and 16 extending therethrough in a disc radial direction. A cover spring 17 is disposed so as to straddle the windows 15 and 16. The cover spring 17 urges the left and right brake pads 9 towards the forward torque-receiving surfaces 14a.

The forward torque-receiving surfaces 14a of the caliper body 2 are each provided with a guide member 18 of substantially a U shape in cross section, as shown in FIGS. 3 and 4. Each guide member 18 has upper and lower bent portions 18a and 18b for engaging with upper and lower corners of the respective forward torque-receiving surface 14a, the lower bent portion 18b being fixed to the caliper body 2 with a screw. The guide members 18 are made of a material such as steel (for example, a cold-rolled steel plate SPCC-4B, a hot-rolled steel plate for automotive structure SAPH-400, or a (normalized) carbon steel for machine structure S15C, all having a hardness of about Hv 120) that has a hardness higher than that of the aluminum alloy of which the caliper body 2 is made.

Therefore, at a time of braking when the vehicle is moving forward, the end surfaces 9a of the brake pads 9 slidingly move while being pressed against the guide members 18. In this way, a braking torque acting on the brake pads 9 is received via the guide members 18 by torque-receiving surfaces 14a. Therefore, even when a large braking torque repeatedly acts on the brake pads 9 during braking operations of the vehicle moving forward, the brake pads 9 are not brought into direct contact with the torque-receiving surfaces 14a having a low hardness. This prevents the caliper body 2 from being recessed due to pressure, deformed due to heat, or the like.

On the other hand, the rearward torque-receiving surfaces 14b of the caliper body 2 are not provided with a guide member 18 such as the ones used for the forward torque-receiving surfaces 14a, and, therefore, are able to directly abut against the end surfaces 9b of the brake pads 9.

As a result, at a time of braking when the vehicle is moving rearward, the end surfaces 9b of the brake pads 9 are brought into direct contact with bare portions of the caliper body 2, that is, the rearward torque-receiving surfaces 14b. As described above, the caliper body 2 is made of an aluminum alloy, which has a relatively low hardness. Therefore, when the brake pads 9 are brought into contact with the rearward torque-receiving surfaces 14b, an impact caused by the contact is buffered by the elasticity of aluminum. In this way, rattling due to a braking operation when the vehicle is moving rearward can be reduced by the elasticity of aluminum of the rearward torque-receiving surfaces 14b, as compared to the guide members 18 having a high hardness.

Further, the disc brake of the present embodiment requires fewer components as the rearward torque-receiving surfaces 14b are not provided with guide members. As a result, the number of parts can be decreased and a manufacturing cost can be reduced.

Further, in manufacturing this disc brake system, the following method can be employed to produce a caliper body 102 that can be adapted for use in either a left or right wheel brake.

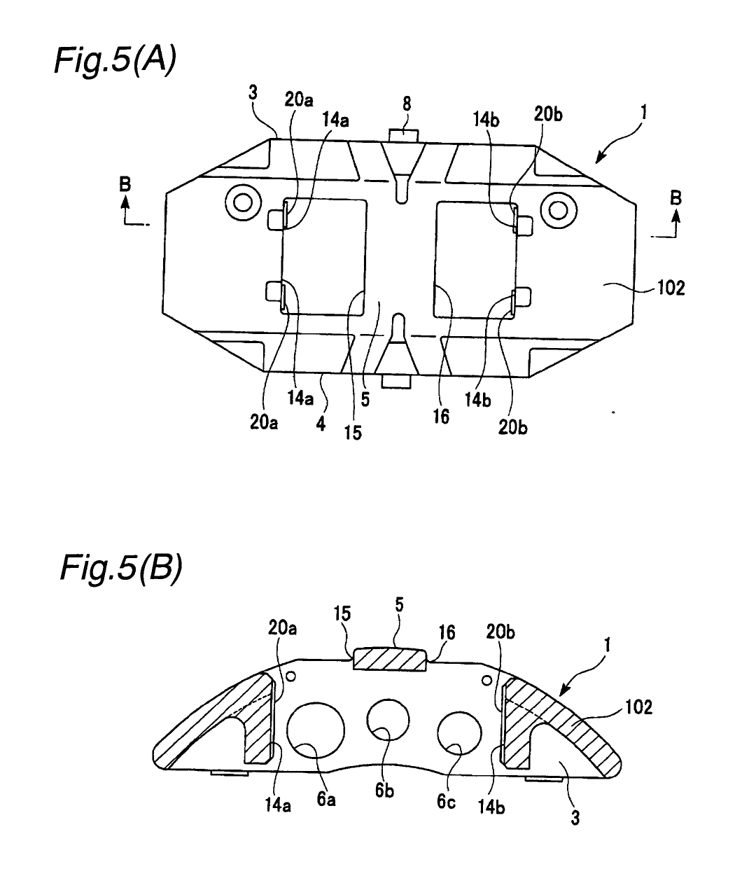

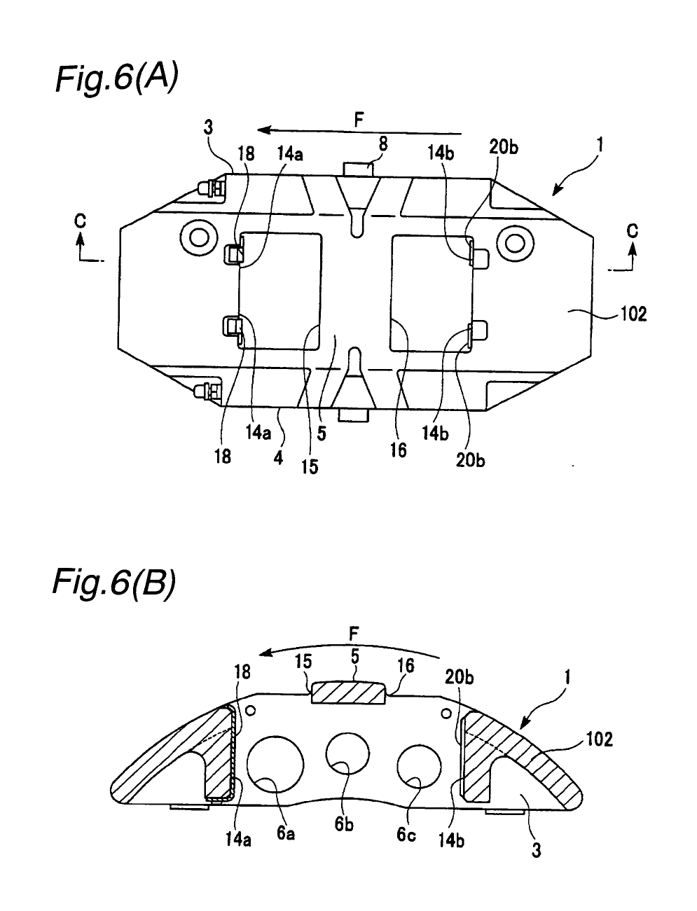

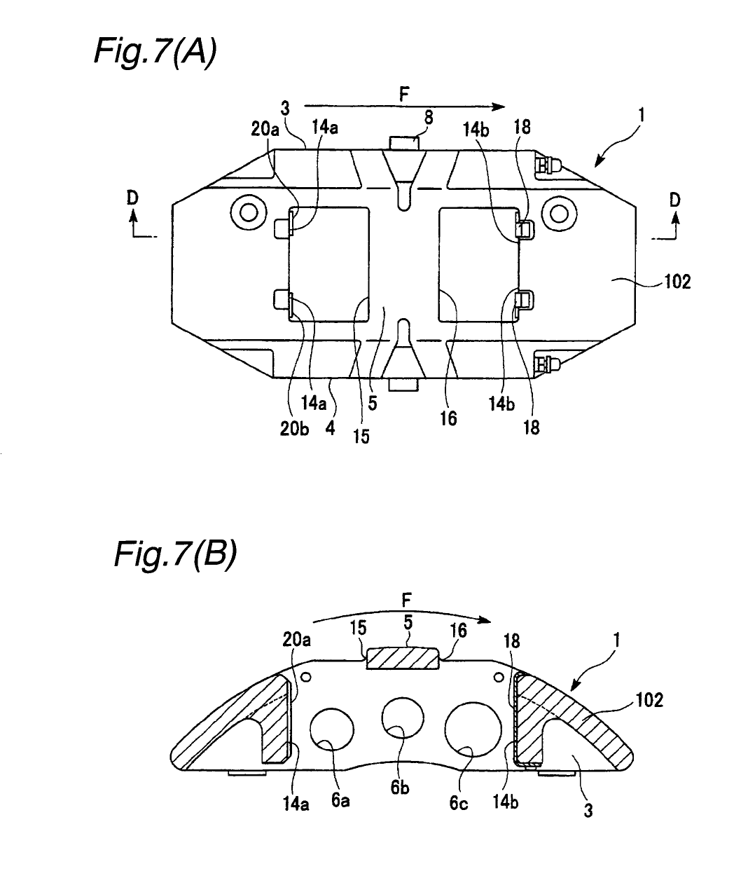

FIGS. 5 to 7 shows the caliper body 102 that can be used for either left or right wheel brake. FIGS. 5 show the caliper body 102 without a guide member 18 being attached thereto, while FIGS. 6 and 7 show the caliper body 102 with a guide member 18 being attached thereto for use for left and right wheels, respectively.

As shown in FIGS. 5 (A) and (B), in a stage of aluminum casting of the caliper body 102, projections 20aand 20b that have a height equal to the thickness of the guide member 18 are formed on the torque-receiving surfaces 14a and 14b, respectively.

Next, as shown in FIGS. 6 (A) and (B), to use the caliper body 102 for one of left and right wheels, the projection 20a on the forward torque-receiving surface 14a is removed to a greater extent than the projection 20b of the torque-receiving surface 14b in a cutting process or the like. Then a guide member 18 is attached to the torque-receiving surface 14a. On the other hand, as shown in FIGS. 7 (A) and (B), to use the caliper body 102 for a wheel on the other side, the projection 20b on the forward torque-receiving surface 14b is removed to a greater extent than the projection 20a on the torque-receiving surface 14a in a cutting process or the like. Then a guide member 18 is similarly attached to the torque-receiving surface 14b. In either case, an amount of removing the projection 20a or 20b more than the other in the cutting process or the like is equal to the thickness of the guide member 18.

As described above, the projections 20a and 20b, which are higher than the thickness of the guide member 18, are formed beforehand on the forward and rearward torque-receiving surfaces 14a and 14b in a casting stage; then either the projection 20a or 20b is removed to a greater extent for attachment of the guide member 18. The reason why such a method is employed is to prevent a brake pad from wearing unevenly due to attachment of the guide member 18 which would otherwise displace a center between the forward and rearward torque-receiving surfaces 14a and 14b from a longitudinal center of the brake pad. In either case of FIG. 6 or 7, the guide member 18 and one of the projections 20b and 20a that is cut to a lesser extent than the other constitute torque-receiving surfaces.

Therefore, by employing this example method of producing the caliper body 102 adapted for use for either a left or right wheel and employing the caliper body 102 produced by the method, manufacturing efficiency can be improved, and uneven wear of the brake pads can be prevented.

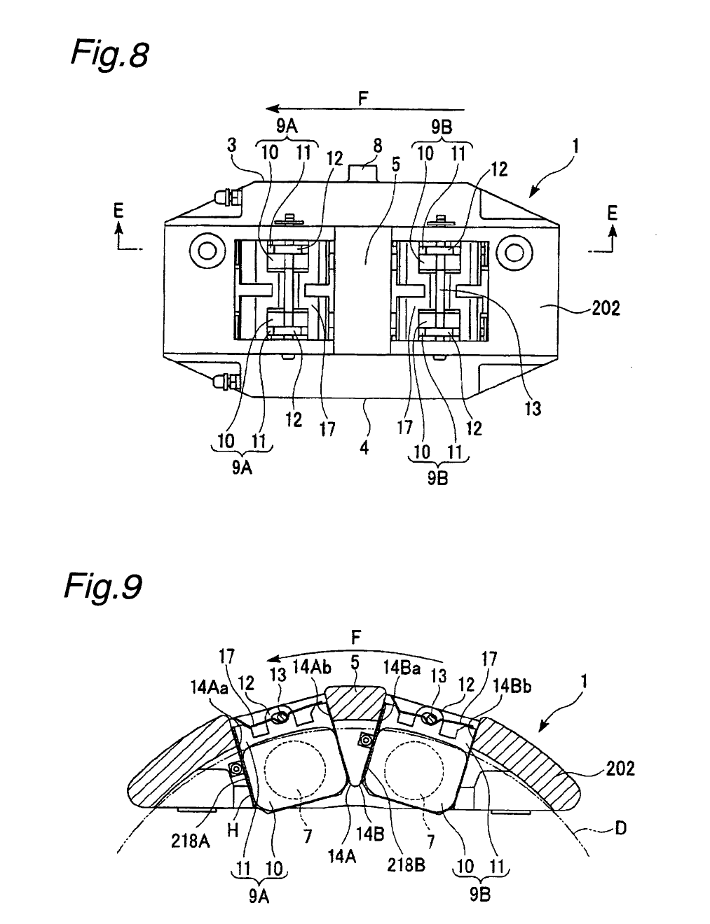

Next, the second embodiment will be described with reference to FIGS. 8 to 10.

In the disc brake of the present embodiment, a caliper body 202 of a brake caliper 1 is made of a single block of aluminum as is the case in the first embodiment. Inner and outer walls 3 and 4 of the caliper body 202 are each provided with two pistons 7 that are arranged side by side in a rotational direction of the disc, the two pistons 7 in the inner wall 3 and the two pistons 7 in the outer wall 4 being disposed in opposing relation to each other. Brake pads 9A and 9B are provided on front surfaces of the pistons 7 on either side of the disc D. The inner and outer walls 3 and 4 each have two guide grooves 14A and 14B for slidably holding the brake pads 9A and 9B. The guide grooves 14A and 14B are provided, on opposite sides thereof in a circumferential direction, with forward torque-receiving surfaces 14Aa and 14Ba and rearward torque-receiving surfaces 14Ab and 14Bb. Opposing sides of each of the guide grooves 14A and 14B in the circumferential direction of the disc are symmetrical to each other.

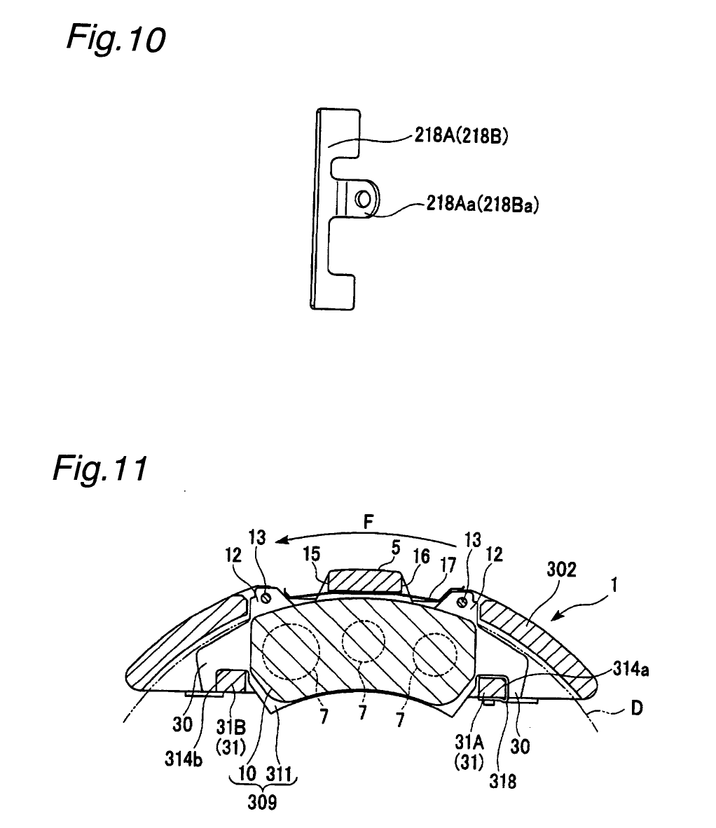

As described in the first embodiment, the disc brake of the present embodiment is provided with guide members 218A and 218B of a high-hardness material such as steel, only on the forward torque-receiving surfaces 14Aa and 14Ba of the guide grooves 14A and 14B. On the other hand, bare aluminum of the rearward torque-receiving surfaces 14Ab and 14Bb, which the caliper body 202 is made of, is exposed to side surfaces of brake pads 9A and 9B. As shown in FIG. 10, the guide members 218A and 218B, respectively, have bent portions 218Aa and 218Ba that are bent at approximately a right angle to a torque receiving surface. The bent portions 218Aa and 218Ba are fixed to the inner wall 3 with a screw. Similarly, guide members 218A and 218B are fixed to the outer wall 4.

The disc brake of the present embodiment has two brake pads 9A and 9B on each side of the disc. For these brake pads 9A and 9B, the high-hardness guide members 218A and 218B are disposed only on the forward torque-receiving surfaces 14Aa and 14Ba. As described in the first embodiment, this can prevent the forward torque-receiving surfaces 14Aa and 14Ba from being recessed due to a pressure or melted by a braking operation when the vehicle is moving forward, and reliably reduce rattling caused by a braking operation when the vehicle is moving rearward.

It is to be noted that the present embodiment is applied to a disc brake that has twice as many brake pads as the disc brake of the first embodiment. Since one guide member can be omitted for each brake pad, the cost can be reduced significantly in the present embodiment that requires fewer guide members 218A and 218B than prior art disc brakes. In the present embodiment, the brake pads 9A and 9B are each provided with one piston 7; however, a plurality of pistons (for example, two) can be disposed on each of the brake pads 9A and 9B.

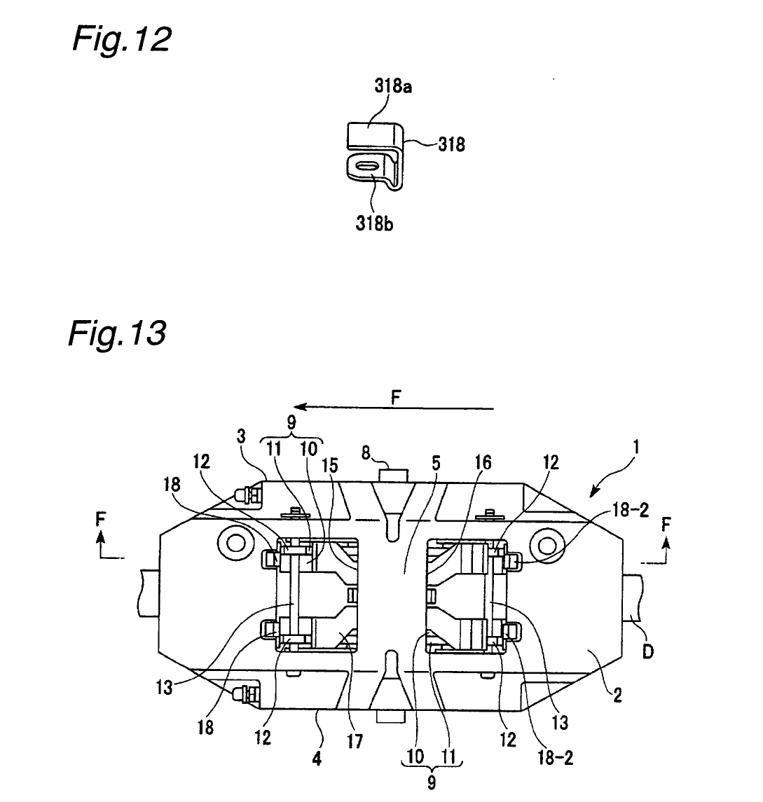

Next, the third embodiment will be described with reference to FIGS. 11 and 12.

The disc brake of the present embodiment has the same numbers of pistons 7, brake pads 309, and so on as that of the first embodiment. A metal backing member 311 for each brake pad 309 has locking hooks 30 extending integrally from the metal backing member 311 in forward and rearward rotational directions of the disc. Therefore, the present embodiment is significantly different from the other embodiments in that these locking hooks 30 are hooked and locked to respective stays 31 that project from a caliper body 302. In the first embodiment, a braking torque acting in a direction of rotation on a brake pad at a time of braking is counteracted by a torque receiving surface which pushes back the brake pad, and is provided on an outgoing side of rotation of the disc D (an exit side in the direction of rotation). In contrast, in the present embodiment, a braking torque acting in a direction of rotation on a brake pad 309 is counteracted by a locking portion which pulls back the brake pad. The locking portion comprises the locking hook 30 and the stay 31 and is provided on an incoming side of rotation of the disc D (on an entrance side in the direction of rotation).

Therefore, in the disc brake of the present embodiment, a front surface of a stay 31A, that is, one of the stays 31 located on the incoming side of disc rotation when the vehicle is moving forward, constitutes a forward torque-receiving surface 314a, while a rear surface of a stay 31B, that is, the other of the stays 31 located on the outgoing side of disc rotation when the vehicle is moving rearward, constitutes a rearward torque-receiving surface 314b. In the present embodiment also, a guide member 318 made of a high-hardness material is provided only on the forward torque-receiving surface 314a, but not on the rearward torque-receiving surface 314b, such that the locking hook 30 can be brought into direct contact with the rearward torque-receiving surface 314b. As shown in FIG. 12, the guide member 318 has upper and lower bent portions 318a and 318b. The bent portions 318a and 318b are engaged with upper and lower surfaces of the stay 31. In this state, the bent portion 318b is fixed to the stay 31 with a screw.

As a result, the disc brake of the present embodiment can obtain the same effects as the above-described embodiments.

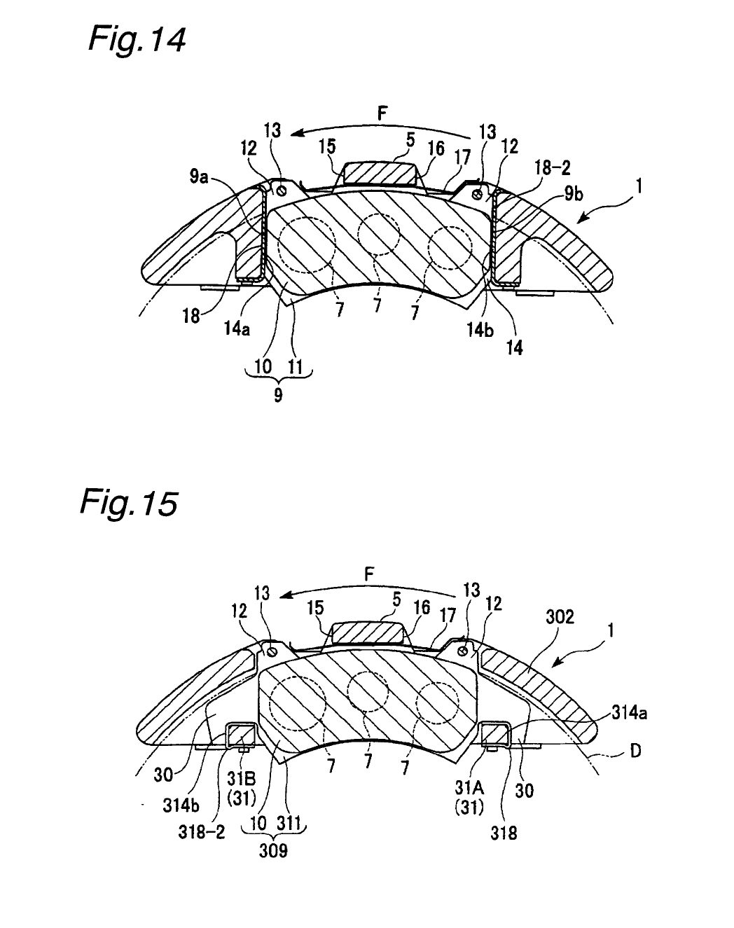

Next, the fourth embodiment shown in FIGS. 13 and 14 and the fifth embodiment shown in FIG. 15 will be described.

The disc brakes of the fourth and fifth embodiments, respectively, have a structure generally corresponding to those of the above-described first and third embodiments, except that rearward torque-receiving surfaces 14b and 314b are respectively provided with guide members 18-2 and 318-2 having a hardness different from those of the forward torque-receiving surfaces 14a and 314a.

Specifically, the guide members 18 and 318 for the forward torque-receiving surfaces have a high hardness, while the guide members 18-2 and 318-2 for the rearward torque-receiving surfaces have a lower hardness than those of the guide members 18 and 318.

To provide the forward and rearward torque-receiving surfaces (hereinafter, referred to as a forward-movement side “and a rearward-movement side”, respectively) with guide members of different hardnesses, the following techniques (1) to (3), for example, can be employed:
(1) When a guide member on the forward-movement side is made of a high-hardness stainless steel strip for spring (hardness: Hv 300), a guide member on the rearward-movement side is made of a cold-rolled steel plate (hardness: Hv 120).
(2) When a guide member on the forward-movement side is made of a steel (such as a cold-rolled steel plate) (hardness: Hv 120), a guide member on the rearward-movement side is made of aluminum (hardness: about Hv 90).
(3) When guide members on the forward- and rearward-movement sides are made of the same structural carbon steel S15C, the guide member on the forward-movement side is subjected to quenching and annealing to obtain a hardness Hv 253 (primary stage: oil cooling from 900° C., secondary stage: water cooling from 780° C. Subsequently, air cooling from 180° C.), while the guide member on the rearward-movement side is subjected to normalizing (air cooling from 900° C.) to obtain a hardness Hv 122.

A technique other than the above-described techniques can be employed to obtain different hardnesses on the front and rear sides. In that case, the ratio of hardness between the guide members on the forward- and rearward-movement sides is preferably made to be about 1.3:1 (namely, forward-movement side hardness: rearward-movement side hardness =about 1.3:1).

In the fourth and fifth embodiments, the guide members 18, 318 are respectively provided on the forward-movement sides of the brake pads 9 and 309, and the guide members 18-2, 318-2 are respectively provided on the rearward-movement sides of the brake pads 9 and 309. However, the hardness of the rearward-movement side's guide members 18-2 and 318-2 is set to be lower than that of the forward-movement side's guide members 18 and 318. This prevents the forward torque-receiving surfaces 14a and 314a from being recessed due to pressure or melted by a braking operation when the vehicle is moving forward, and reduces rattling caused by a braking operation when the vehicle is moving rearward, as described in the other embodiments.

According to the embodiments, the brake pads abut, via high-hardness guide members, against forward torque-receiving surfaces during a braking operation when the vehicle is moving forward. On the other hand, during a braking operation when the vehicle is moving rearward, the brake pads are brought into contact with low-hardness rearward torque-receiving surfaces of the caliper body so as to cushion an impact caused by the contact. Therefore, that can prevent a pressure recess from being formed during a braking operation when the vehicle is moving forward, and effectively reduce rattling caused by a braking operation when the vehicle is moving rearward.

Further, according to the embodiments, they require fewer components, since the rearward torque-receiving surfaces of the caliper body are not provided with a guide member. Therefore, a manufacturing cost can be reduced.

According to the embodiments, the disc brake comprises a plurality of pistons and brake pads on each side of the disc. That can prevent a pressure recess from being formed during a braking operation when the vehicle is moving forward and reduce rattling caused by a braking operation when the vehicle is moving rearward. Further, the number of guide members can be greatly reduced, which leads to a significant cost reduction.

According to the embodiments, the brake pads abut, via high-hardness guide members, against the forward torque-receiving surfaces during a braking operation when the vehicle is moving forward. During a braking operation when the vehicle is moving rearward, the brake pads are brought into contact with low-hardness guide members so as to cushion an impact caused by the contact. Therefore, that can prevent a pressure recess from being formed during the braking operation when the vehicle is moving forward, and effectively reduce rattling caused by the braking operation when the vehicle is moving rearward.

According to the embodiments, the caliper body is made of aluminum, while the guide members are made of steel. Therefore, in particular, that 4 can effectively prevent a pressure recess from being formed during a braking operation when the vehicle is moving forward, and reduce rattling caused by a braking operation when the vehicle is moving rearward.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention. The above embodiments are described in terms of a hydraulic disc brake as an example; however, this invention can also be applied to other devices such as an electrically actuated brake having a pressing means that is driven by an electric motor.

The entire disclosure of Japanese Patent Application No. 2005-288337 filed on Sep. 30, 2005 including specification, claims, drawings and summary is incorporated herein by reference in its entirety.

What is claimed is:

1. A disc brake comprising:
a caliper body having a plurality of pressing means that are disposed, via a disc pass portion, in opposing relation to each other on either side of a disc which is adapted to rotate with a vehicle axle;
a pair of brake pads which are disposed on either side of the disc, the brake pads being supported by the caliper body so as to be capable of slidably moving in an axial direction of a disc;
the caliper body comprising:
forward torque-receiving surfaces for receiving a braking torque from the brake pads during a braking operation when a vehicle is moving forward; and
rearward torque-receiving surfaces for receiving a brake torque from the brake pads during a braking operation when the vehicle is moving rearward,
the forward torque-receiving surfaces and the rearward torque-receiving surfaces being provided in symmetrical relation to each other in a circumferential direction of the disc,
wherein only the forward torque-receiving surfaces are each provided with a guide member for abutment with the brake pads, while the rearward torque-receiving surfaces can be brought into direct contact with the brake pads, and
wherein the caliper body is made of a material having a hardness lower than that of the guide members.

2. A disc brake according to claim 1,
wherein the pressing means comprise a plurality of pistons on each side of the disc, each of the pistons being provided on the respective brake pad, and
wherein the caliper body has a forward torque-receiving surface and a rearward torque-receiving surface on either side of each brake pad in a circumferential direction of the disc, the forward torque-receiving surface and the rearward torque-receiving surface being symmetrical in shape to each other, only the forward torque-receiving surface being provided with the guide member.

3. A disc brake according to claim 1, wherein
the caliper body comprises
an inner wall facing a surface of the disc on an inboard side of the vehicle, and
an outer wall facing a surface of the disc on an outboard side of the vehicle,
the inner wall and the outer wall being connected to each other by the disc pass portion,
the inner and outer walls each having two guide grooves for slidably holding the brake pads,
the guide grooves being provided, on opposite sides thereof in a circumferential direction, with forward torque-receiving surfaces and rearward torque-receiving surfaces,
guide members of high-hardness material being provided only on the forward torque-receiving surfaces of the guide grooves.

4. A disc brake according to claim 1, wherein
a metal backing member is attached to each of the brake pads and has locking hooks extending integrally from the metal backing member in forward and rearward rotational directions of the disc,
the locking hooks are hooked and locked to respective stays that project from the caliper body,
a front surface of one of the stays located on the incoming side of disc rotation when the vehicle is moving forward, constitutes the forward torque-receiving surface,
a rear surface of the other of the stays located on the outgoing side of disc rotation when the vehicle is moving rearward, constitutes the rearward torque-receiving surface, and
the guide member made of a high-hardness material is provided only on the forward torque-receiving surface, but not on the rearward torque-receiving surface 314b, such that the locking hook can be brought into direct contact with the rearward torque-receiving surface.

5. A disc brake comprising:
a caliper body having a plurality of pressing means that are disposed, via a disc pass portion, in opposing relation to each other on either side of a disc which is adapted to rotate with a vehicle axle;
a pair of brake pads which are disposed on either side of the disc, the brake pads being supported by the caliper body so as to be capable of slidably moving in an axial direction of a disc;
the caliper body comprising torque receiving surfaces on which the brake pads abut during a vehicle braking operation,
each of the torque receiving surfaces being provided with a guide member,
wherein hardness of the guide members on the rearward torque-receiving surfaces, on which the brake pads abut during a braking operation when the vehicle is moving rearward, is lower than that of the guide members on the forward torque-receiving surfaces, on which the brake pads abut during a braking operation when the vehicle is moving forward.

6. A disc brake according to claim 5, wherein
the ratio of hardness between the guide members on the forward- and rearward-movement sides is made to be about 1.3:1.

7. A disc brake according to claim 1, wherein the caliper body is made of aluminum, while the guide members are made of steel.

8. A disc brake according to claim 2, wherein the caliper body is made of aluminum, while the guide members are made of steel.

9. A disc brake according to claim 5, wherein the caliper body is made of aluminum, while the guide members are made of steel.

10. A method for producing a disc brake of claim 1 comprising the steps of:
forming projections that have a height equal to the thickness of the guide member on the respective torque-receiving surfaces of the caliper body,
removing the projection on the forward torque-receiving surface to a greater extent than the projection of the rearward torque-receiving surface in a cutting process to use the caliper body for one of left and right wheels, an amount of removing the projection on the forward torque-receiving surface more than the projection of the rearward torque-receiving surface in the cutting process or the like being equal to the thickness of the guide member, and
attaching the guide member to the forward torque-receiving surface.
